(19) United States
(12) Patent Application Publication
(10) Pub. No.: US 2011/0195391 A1
(43) Pub. Date: Aug. 11, 2011

(54) METHOD OF LEARNING ARITHMETIC

(76) Inventor: Lori Stone, Winnetka, IL (US)

(21) Appl. No.: 13/032,518

(22) Filed: Feb. 22, 2011

Related U.S. Application Data
(63) Continuation-in-part of application No. 11/281,127, filed on Nov. 17, 2005.

(51) Int. Cl. G09B 25/00

(52) U.S. Cl. 434/365

(57) ABSTRACT

A learning method including the steps of conveying to an individual: a first number through a first representation that relates to subject matter understood to be identified with the first number in conjunction with at least one other word; a symbol for a first arithmetic operation; a second number through a second representation that relates to subject matter understood to be identified with the second number in conjunction with at least one other word; and at least one word associated with at least one of the first and second graphical representations, the at least one word containing information suggesting a third number that is a result of performing the first arithmetic operation using the first and second numbers without identifying the third number by itself.

### CROSS-REFERENCE TO RELATED APPLICATIONS

This application is a continuation-in-part of U.S. Ser. No. 11/281,127 filed Nov. 17, 2005.

### BACKGROUND OF THE INVENTION

1. Field of the Invention

This invention relates to teaching methods, and in more particular applications, to a method and system of teaching arithmetic.

2. Background Art

In elementary school, children are expected to have mastered basic arithmetic skills. However, the mastery of such skills is often a difficult task for many youngsters. Children tend to be more concrete in their thinking and, therefore, often have trouble working with numbers, which requires abstract thinking.

Many devices and methods have been devised to teach arithmetic; for example, posters, flash cards, objects that can be manipulated (e.g., marbles), and more recently, video and computer games. In each of these approaches, an arithmetical question is posed (e.g., “3×3=?”) and then a numerical answer is given (e.g., “9”). Although there have been many variations upon these devices as a means to instruct children in basic arithmetical concepts, they remain a comparatively poor learning method because they fail to associate abstract numbers with concrete objects in a manner that facilitates accurate recall. Again, all of these variations utilize the basic technique of either teaching abstract numbers as such or teaching abstract numbers by equating them with a corresponding number of unrelated objects. This technique does not assist the child in remembering the sum, remainder, or product of two numbers other than through rote memorization or by counting on their fingers. In addition, young children typically have a limited attention span and become easily bored if their imagination is not stimulated. Posters, flash cards, objects, or video/computer games utilizing abstract numbers—even those containing pictorial representations of those numbers—fail to capture the imagination of most children for any length of time or encourage prolonged interaction with them because they are ultimately based on the memorization of abstract numerical facts.

### SUMMARY OF THE INVENTION

in one form, the invention is directed to a learning method including the steps of: providing at least one viewable object; through the at least one viewable object visually conveying to an individual a first number or a suggestion of a first number through a first image on the at least one viewable object made up of at least one of: (a) at least one of a person, place or thing understood to be identified with the first number in conjunction with at least one word; and (b) a characteristic of at least one of a person, place or thing understood to be identified with the first number in conjunction with the at least one word, the first image relating to a first part of a story; through the at least one viewable object, visually conveying to the individual a second number or a suggestion of a second number through a second image on the at least one viewable object made up of at least one of: (a) at least one of a person, place or thing understood to be identified with the second number in conjunction with at least one other word; and (b) a characteristic of at least one of a person, place or thing understood to be identified with the second number in conjunction with the at least one other word, the second image relating to a part of the story; and through the at least one viewable object, visually conveying to the individual one of: a) a suggestion of a third number; and b) the third number that is the result of a first arithmetic operation using the first and second numbers through a third image on the at least one viewable object made up of at least one of: (a) at least one of a person, place or thing understood to be identified with the third number in conjunction with at least another word; and (b) a characteristic of at least one of a person, place or thing understood to be identified with the third number in conjunction with the at least another word. The third image relates to an outcome of the story and is related to the first and second images so that an individual is led through the first and second images to conclude the story with the outcome to which the third image relates.

In one form, the first and second numbers are the same.

The first and second numbers may be different.

The method may further include the step of conveying to the individual one or more words suggesting the third number.

The steps of conveying may be performed through visual communication.

In one form, at least one of the conveying steps involves conveying to the individual through printed media.

The method may further include of pre-training the individual so that the individual understands an intended relationship between at least one of the images and a number associated with the at least one of the images and identified with a number in conjunction with at least one word.

The invention is further directed to a learning method including the steps of: conveying to an individual a first number through a first graphical representation that relates to subject matter understood to be identified with the first number in conjunction with at least one other word; conveying to the individual a symbol for a first arithmetic operation; conveying to the individual a second number through a second graphical representation that relates to subject matter understood to be identified with the second number in conjunction with at least one other word; and conveying to the individual at least one word associated with at least one of the first and second graphical representations, the at least one word containing information suggesting a third number that is a result of performing the first arithmetic operation using the first and second numbers without identifying the third number by itself. At least one of the conveying steps involves conveying through printed media what is observed by the individual.

The first graphical representation may include at least one of: (a) at least one of a person, place or thing; and (b) a characteristic of at least one of a person, place or thing understood to be identified with the first number in conjunction with at least one other word.

The first and second numbers may be the same or different.

The first and second graphical representations may be the same or different.

In one form, the method further includes the step of pre-training the individual so that the individual understands and intended relationship between at least one of the images and a number associated with the at least one of the images and identified with a number in conjunction with at least one word.

The invention is further directed to a system for learning arithmetic operations. The system includes a plurality of cards each having a front side and a back side. The front side of a first card has a first number together with a first graphical representation that is understood to be identified with the first graphical representation in conjunction with at least one other word. The front side has a second number together with a second graphical representation understood to be identified with the second number in conjunction with at least one other word. A symbol is provided on the front side for a first arithmetic operation. The front side further has a word associated with at least one of the first and second graphical representations. The word contains a clue suggesting a third number that is a result of the first arithmetic operation without identifying the third number by itself. The back side of the first card includes the third number or a graphical representation that is understood to be identified with the third number in conjunction with at least one other word.

The first and second numbers may be the same or different.

The first and second graphical representations may be the same or different.

Other objects, advantages, and features will become apparent from a complete review of the entire specification, including the appended claims and drawings.

### BRIEF DESCRIPTION OF THE DRAWINGS

FIG. 1 is a block diagram of a method depicting one embodiment of the present invention;

FIG. 2 is a flow diagram depicting the steps of an example using the present invention;

FIG. 3 is a block diagram of a method depicting another embodiment of the present invention;

FIG. 4a is a front face of a card in one embodiment of the present invention;

FIG. 4b is a back face of the card of FIG. 4a;

FIG. 5a is a front face of a card in another embodiment of the present invention;

FIG. 5b is a back face of the card of FIG. 5a;

FIGS. 6 and 7 are illustrations of materials used to train users and showing images and their association with a number and a word or words;

FIG. 8 is an illustration of a viewable card or other object used to convey a mathematical operation with two numbers and a mathematical operator;

FIG. 9 is an illustration as in FIG. 8 utilized to convey the result of the mathematical operation in FIG. 8;

FIG. 10 is an illustration of another viewable card or object as in FIG. 8;

FIG. 11 is an illustration as in FIG. 10 utilized to convey the results of the mathematical operation in FIG. 10;

FIG. 12 is an illustration of a card or other object generically depicting the subject matter in FIGS. 8-11;

FIG. 13 is an illustration corresponding to that in FIGS. 8 and 10 wherein the invention is practiced in a different manner, starting with the answer and one of the numbers used in the mathematical operation; and

FIGS. 14 and 15 illustrate viewable cards or other objects used to train with respect to shortcuts for the numbers “0”, “1” and “10”.

### DETAILED DESCRIPTION OF THE PREFERRED EMBODIMENT

The present invention will be described hereinafter as a learning method and learning system such as a system including multi-sided cards. However, it should be understood that the invention is applicable to other learning methods, media and systems used in other contexts, for example, a learning system using computer software, video game software, or interactive DVD programs, as well as other printed media. Accordingly, no limitation to any particular use is intended except insofar as expressed in the appended claims.

The present method and system uses persons, places, things, words and/or phrases understood to be associated with numbers which are presented to be sensed by an individual in a meaningful context, such as by presenting a story using the persons, places, things, words and/or phrases. As used throughout the description and claims herein, persons, places, things, words and/or phrases includes: real or imaginary—persons, places, things, words, phrases, books, titles, numbers, events, countdowns, plays on words, jokes, rhymes, songs, names, titles, stories, idioms, images, symbols, shapes, sports, games, applications [cell phone apps], activities, actions [high 5], contests, television shows, plays, and/or one or more characteristics of the foregoing. These persons, places, things, words and/or phrases may be familiar in nature and commonly associated with numbers. Alternatively, individuals may be pre-trained as to the persons, places, things, phrases and/or their association with numbers used to identify the same in conjunction with one or more words. The story may include mnemonic and other memory techniques to encourage learning and strengthen memory recall. Such a method and system may be suitable for children, who tend to conceptualize in concrete rather than in abstract terms, or for others who encounter difficulty in memorizing abstract numbers and equations.

Referring to FIG. 1, one embodiment of the present learning method is shown. As shown in FIG. 1, a variety of information is conveyed to an individual 10. The method includes a step of conveying to the individual 10 a first number or a suggestion of a first number, together with the identification of at least one of (a) at least one of a person, place or thing understood (through common knowledge or pre-training) to be associated with the first number and (b) a characteristic of at least one of a person, place or thing understood to be associated with the first number, as represented by box 12. The method also includes a step of conveying to the individual 10 a second number or a suggestion of a second number together with the identification of at least one of (a) at least one of a person, place or thing understood (through common knowledge or pre-training) to be associated with the second number and (b) a characteristic of at least one of a person, place or thing understood to be associated with the second number, as represented by box 14. Additionally, the method includes a step of conveying to the individual one of a) a suggestion of a third number and b) the third number that is the result of a first arithmetic operation using the first and second numbers together with the identification of at least one of (a) at least one of a person, place or thing understood (through common knowledge or pre-training) to be associated with the third number and (b) a characteristic of at least one of a person, place or thing understood to be associated with the third number, as represented by box 16.

As exemplified by box 12, this step includes conveying to the individual 10 a first number, such as any of the numbers 0-9 or numbers greater than 9, or a suggestion of the first number. The suggestion may include any number of representations that suggest the first number such as words, phrases, shapes or any other representation that brings to the individual's 10 mind the first number without requiring any mathematical calculations to make an association between the representations and the first number. The conveyance may be by way of any information that is sensed by a user, be it by sight, hearing, smell, feel, etc.

Furthermore, step 12 includes conveying the identification of at least one of (a) at least one of a person, place or thing understood to be associated with the first number and (b) a characteristic of at least one of a person, place or thing understood to be associated with the first number. The person, place, thing or characteristic is either commonly associated with the first number, may be either directly or indirectly associated with the first number, or may be associated as a result of pre-training. For example, suitable persons may include the seven dwarfs, which is commonly associated with the number seven. Similarly, suitable things include a four-leafed clover which is commonly associated with the number four or an eight ball which is associated with the number eight. Additionally, the “thing” may also include sounds, smells, and/or tactile objects that may be commonly associated with the number. The step 14 of conveying a second number or a suggestion of a second number may include similar persons, places, things or characteristics of a nature that no mathematical calculations are required to make an association between the identification and the second number. The first and second numbers may be the same or different.

The method also includes the step 16 of conveying to the individual a suggestion of the third number and/or the third number itself. The third number is the result of an arithmetic operation using the first and second numbers. For example, suitable arithmetic operations include addition, subtraction, multiplication, division or other arithmetic operations. The step 16 also includes conveying at least one of (a) at least one of a person, place or thing understood to be associated with the third number and (b) a characteristic of at least one of a person, place or thing understood to be associated with the third number. The person, place, thing or characteristic may also be anything understood (through common knowledge or pre-training) to be associated with the third number, similar to those used for the first and second numbers, or one wherein the association is acquired as through pre-training, and is such that no mathematical calculations are required to make an association between (a) or (b) and the third number.

For example, conveying the number “8” together with the depiction of an eight ball, does not require that the individual count eight objects to relate the “eight ball” to the number “8”. Similarly, with the depiction of the “seven dwarfs”, the association with the number “7” can be made by recognizing the dwarfs as numbering “7” without requiring a counting exercise. It is the objective to make an immediate association between a person, place, or thing (or characteristic thereof) and a number. In this manner, the individual makes a unique mental connection between the first and second numbers, the arithmetic operation, and the third number without simple rate memorization that may be ineffective or require a very large number of repetitions to be effective. That is, the individual makes a relationship between two numbers, the arithmetic operation, and the resulting third number, through a process involving the recognition of identification associated with the numbers, without any mathematical calculations such as counting.

The value in having the identification associated with all three numbers is that the individual can relate, through such identifications, the two numbers as well as the third number that is the result of the operation performed using the two numbers. This creates a memorable interaction between all three numbers.

The claimed method is a quick and easy learning method for arithmetic equations that offers an alternative to existing time-consuming, tedious and error-prone techniques for learning such equations, notably rote memorization of numbers through dedicated repetition, and calculation involving counting individual numbers or objects corresponding in quantity to those numbers after an arithmetic function is performed. Instead, the individual makes the relationship between the two numbers, the arithmetic operation, and the resulting third number through the claimed identifications for each of the three numbers. This not only improves retention, but makes the learning experience more enjoyable compared to conventional learning techniques.

An example of how a fact is learned, using prior art methods and the inventive method, is explained below, with reference to exemplary prior art patents: U.S. Pat. Nos. 5,868,893 (Williams); and 6,716,033 (Lassowsky).
FACT: 5×18=?
1. Arriving at the Answer
Using other methods (Williams, Lassowsky, etc.)
5 (dots, squares, crosses, cico, etc.)×18 (dots, squares,
crosses, eighteen, deiz y ocho, etc.)=?
Hint: add the total dots, squares, crosses, Spanish number, etc.

$$1. ARRIVING AT THE ANSWER$$

$$Using other methods ( Williams , Lassowsky , etc . )$$

$$5 ( dots , squares , crosses , cinco , etc . ) \times 18 ( dots , squares , \\ crosses , eighteen , deiz y ocho , etc ) = ? \\ Hint \text{:} add the total dots , squares , crosses , Spanish$$

$$number , etc . \\ \begin{matrix}5 & … & \times 18 & … & = ? & … & … & … & … & … \\ & & & … & & … & … & … & … & … \\ & & & … & & … & … & … & … & \\ & & & … & & … & … & … & … & \end{matrix}$$

So what is the answer to the above fact using the dots, squares, crosses, Spanish names of the numbers, etc. employed by Lassowsky & Williams? Most adults won't know the answer without computing it by either counting each dot, square, cross, etc. or by using other math to arrive at the answer. Then they would have to employ repetitive rote memorization (recall based on tedious repetition) of the three numbers involved in order to recall it in the future. This is the challenge faced by a child learning each arithmetic fact. And this is a relatively easy equation because it involves a 5. But regardless of its relative simplicity, the answer can only be arrived at through mathematical computation or by counting the total number of dots, squares, crosses, etc.

Applying Williams to the above equation would require computing the answer by counting the number of dots. A “hint” is given, which is actually just restating the numbers “5”×“18” in Spanish (“cinco”×“diez y ocho”) and English (“five” and “eighteen”), which is obviously of no help in arriving at the product (it merely helps one learn the Spanish and English name for numbers). One would still have to count all the dots and then memorize the three numbers making up the equation together. [Williams proposes an addition and subtraction card game (not multiplication) with two decks that are distinguished by a different pattern on the back of each deck, with numbers on the front cards of each deck represented by an equal number of dots. It requires computation—counting all the dots on the two cards and then memorizing the three abstract integers in the equation.] Lassowsky is likewise of no help: again, one would have to count each square, cross, dot, etc. to arrive at the product of the two multipliers, and then memorize the three numbers in the equation together. Lassowsky's “hint” is just a depiction of the product as an equal number of dots, squares, crosses, etc. It is not really a “hint;” it is the answer, depicted in dots, squares, crosses, etc. Counting the total number of squares, crosses or dots is laborious and time-consuming. For even higher products, it would be infeasible to go beyond a certain numerical threshold.
Arrixing at the Answer
Using the inventive method
Depiction of High-5 hands×18-wheeler truck=?
Hint: Depiction of a sign designating the 9th-Tee and a flag on
the 9th hole

For the fact “5×18,” our method would show a golf course with two High-fiving hands swinging an 18-wheeler truck as if it were a golf club, with a sign for the 9th Tee (9-Tee=90) and a red-flagged 9th hole (9-0) as hints, along with some associated dialog. On the back of the card, the hands would High-5 the 18-wheeler truck because their score is 9 hole-in-ones (9-0). The product, 90, follows from the interaction of the first two characters (High-5 and 18-wheeler truck) in a setting (golf course) associated with the product. This is accomplished without mathematical computation or repetitive rote memorization of three abstract, otherwise unrelated integers in an equation. When asked what the product of 5×18 is, a child would think of the character for 5 (High-5) and the character for 18 (18-wheeler truck) and recall their interaction on the 9th-tee and 9th hole.
2. Checking the Correctness of the Answer
Using other methods
90 (dots, squares, crosses, five, noventa, etc.)
=______×______?

If supplied with only the product of the two multipliers at a future date (“90”), most adults would be hard pressed to recall the multipliers that made up the equation unless they used other math to figure it out or spent substantial time committing it to long-term memory through repetitive rote memorization. The only way to double check whether “5×18” is, in fact, “90” or whether “90” is, in fact, the product of “5×18” would be through computation.

Using the Inventive Method

90 (9th hole, 9th-Tee)=High-5 hands×18-wheeler truck

If supplied with only the product of the two multipliers at a future date (“90”), an adult could easily check its correctness by recalling the 9th hole or the 9th-Tee with the High-5 hands clapping the 18-wheeler truck on the green. This is accomplished without any need for computation or repetitive rote memorization of the three abstract integers that make up the equation. The product itself suggests the other two numbers because they all interact together in the same story setting. This is not true for the other patented methods: the product does not provide any hint as to what the multipliers might be.

### SUMMARY

The inventive method does not involve any counting or computation whatsoever, so it has no numerical threshold. Arguably, any product could be portrayed. Rather than depicting abstract numbers with no discernible connection, the inventive method involves the interaction of, in one exemplary form, cartoon characters having pre-existing numerical associations (that may or may not be reflected by the number of characters, e.g., 3 little pigs vs. cloud 9) in a story-like setting that suggests the product. (When you think of the character, you think of the number, and vice versa). Once the product is portrayed at story's end, it is easy to remember the product by recalling the characters' interaction. Hence, “5×18,” rather than remaining two abstract numbers that must be computed or memorized along with the product “90,” becomes two High-5 hands×an 18-wheeler truck interacting at the 9th-Tee and 9th hole. Since all three numbers interact together in a story-like format, they are easily remembered together: the High-5 hands swinging the 18-wheeler truck brings the 9th-Tee/9th hole to mind, and 90 or 9-Tee brings the High-5 hands swinging the 18-wheeler truck to mind.

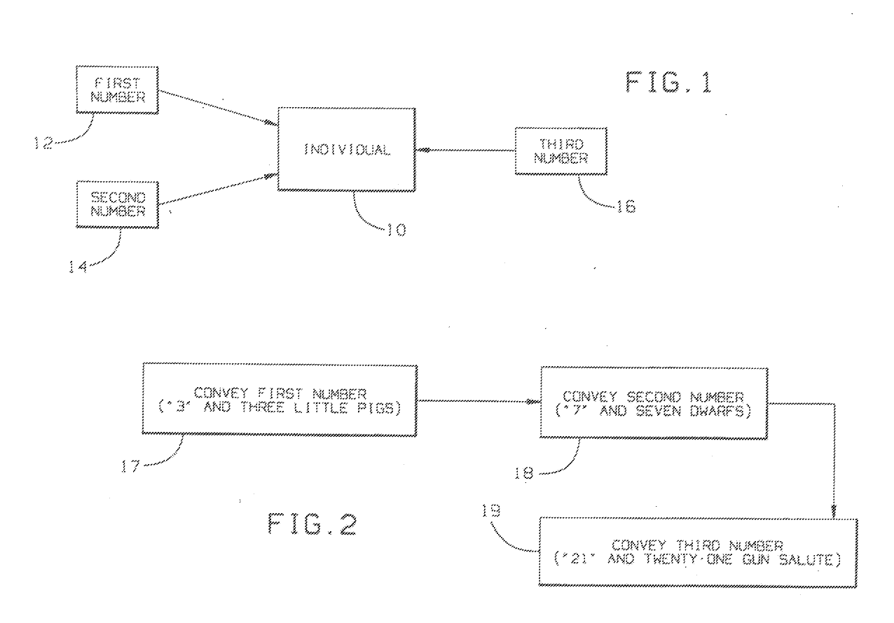

FIG. 2 depicts a flow diagram of one example of the above method. In a first step 17, the number “3” is conveyed along with “the three little pigs” which is commonly associated with the number “3.” In a second step 18, the number “7” is conveyed along with “the seven dwarfs” which is commonly associated with the number “7.” Finally, in a third step 19, the number “21” is conveyed, the result of multiplying “3” times “7”, along with a “twenty-one gun salute” which is commonly associated with the number “21.” It should be understood however, that these steps need not appear in this order.

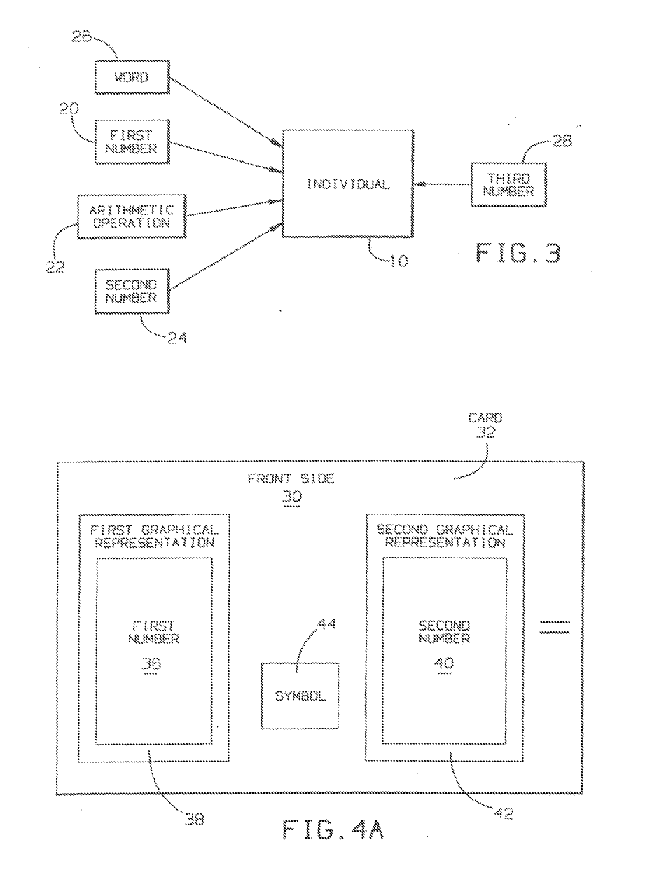

Referring to FIG. 3, another embodiment of the learning method is shown. This method includes the step of conveying to an individual 10 a first number through a first graphical representation understood to be associated with the first number, as represented by box 20. The method also includes the step of conveying to the individual 10 a symbol for a first arithmetic operation, as represented by box 22. Further, the method includes the step of conveying to the individual 10 a second number through a second graphical representation understood to be associated with the second number, as represented by box 24. The method also includes the step of conveying to the individual 10 a word associated with at least one of the first and second graphical representations, the word containing information suggesting a result of performing the first arithmetic operation using the first and second numbers, as represented by box 26. Furthermore, the method includes the step of conveying to the individual 10 a third number that is the result of performing the first arithmetic operation using the first and second numbers, as represented by box 28. The third number may also include a third graphical representation and/or word.

The first, second and third graphical representations can be any suitable visual presentation of information that is understood (through common knowledge or pre-training) to be associated with the first, second and third numbers. For example, the graphical representations may include people, places, things, characteristics, words, stories or other suitable visual presentations. These graphical representations will be discussed in detail below.

Further, the invention contemplates any manner of conveying to an individual the information associated with the numbers. Any manner of conveyance that might be sensed by an individual, through vision, hearing, tactile sensation, smell, etc., is contemplated herein.

Still further, as the visually detectable information, it should be understood that the information may be in “hard” form or electronic form, which will collectively be characterized as printed forms. More specifically the information may be conveyed through (1) visual communication, including, but not limited to graphical representation through printed, televised, electronic, digital, or other visual medium; (2) audio communication, including but not limited to, verbal representation through recorded, broadcast, acting, or other audio medium; and/or (3) tactile communication, including any three-dimensional medium.

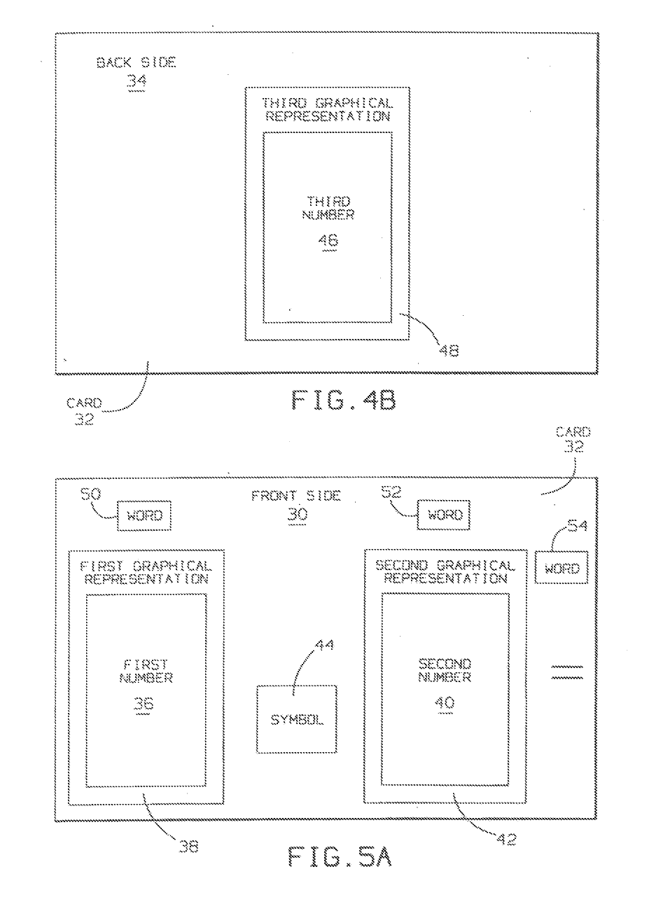

Another embodiment is shown in FIGS. 4a-b. In this embodiment, a system is provided for learning arithmetic operations. The system includes a plurality of cards. FIG. 4a shows a front side 30 of a card 32 while FIG. 4b shows a back side 34 of the card 32. The front side 30 includes a first number 36 together with a first graphical representation 38 that is understood to be associated with the first number 36. The front side 30 also includes a second number 40 together with a second graphical representation 42 that is understood to be associated with the second number 40 plus an “=” sign and optionally a question mark “?”. Additionally, the front side 30 includes a symbol 44 for a first arithmetic operation. The back side 34 of the card 32 includes a third number 46 that is the result of performing the first arithmetic operation using the first and second numbers. The back side 34 may also include a third graphical representation 48, as seen in FIG. 4b. It should be understood that the regions, such as the graphical representations 38 and 42, as well as the other regions shown in all of the figures herein are merely diagrammatic and the actual regions may take any shape, size or location on the card 32 or other medium.

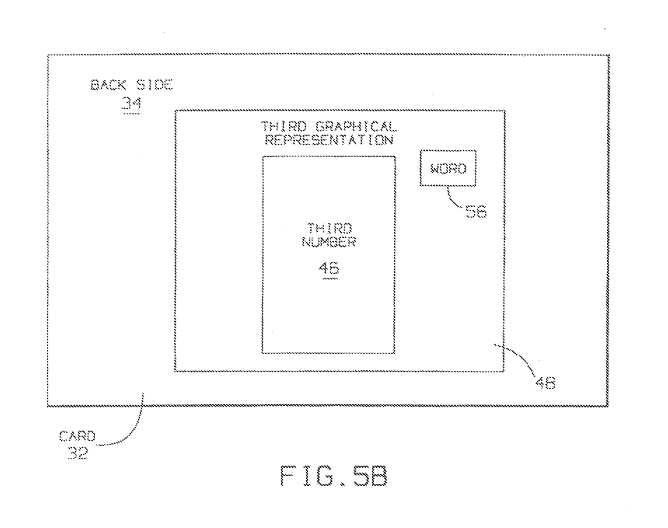

A further embodiment is shown in FIGS. 5a-b. This embodiment is similar to that shown in FIGS. 4a-b, but includes additional features. Specifically, in this embodiment, the card 32 includes at least one word. As shown in FIGS. 5a-b, the card 32 includes a word 50 associated with the first number 36, a word 52 associated with the second number 40, a word 54 suggesting the third number 46 and a word 56 associated with the third number 46. It should be understood by those skilled in the art that each of the words 50,52,54,56 may also include a plurality of words, a phrase, a sentence or the like. Furthermore it is not required to have all of the words 50,52,54,56 on the card 32. In some instances only one word, such as word 54 may be included on a card 32. However, it should be understood that any number and combination of words 50,52,54,56 may be included on the card 32.

The embodiments described above can be used as a learning method and/or system by an individual to learn a variety of arithmetic operations. The use of the numbers, such as the first, second and third numbers 36,40,46 can also be utilized to further reinforce the arithmetic operation. For example, the shape of the numbers can be used as mnemonic devices to suggest to the individual the answer to the problem or help them remember how to determine the answer.

Additionally, the use of a person, place, thing or characteristic can also further reinforce the arithmetic operation and/or solution to the problem. To even further reinforce remembering the answers to the arithmetic problems, the person, place, thing or characteristic may be the same for the same number throughout the entire plurality of cards or for the duration that the method is being used. For example, an eight ball may be associated with the number eight and used the entire duration that the method is used or used on all of the cards to represent the number eight. However, it is also contemplated that the person, place, thing or characteristic may change for the same number for the method or system.

The person, place, thing or characteristic may take the form of one of the graphical representations. The graphical representation may be located adjacent the respective number or even superimposed in front of or behind the respective number as diagrammatically shown in FIGS. 4a-b and 5a-b. However, it should be understood that the person, place, thing or characteristic may be located anywhere.

The graphical representations themselves may include a variety of shapes, people, places, things, characteristics and the like to further reinforce the arithmetic problem. The graphical representations may include a two-faced character for representing the number two, the three little pigs for representing the number three, a four leafed clover for representing the number four and so on.

Additionally, the graphical representations may include a variety of colors that are appealing to the individual. For example, bright colors may be used to attract the individual's attention to certain aspects of the graphical representation. Furthermore, the graphical representations may include humorous sketches, action, absurd scenarios and the like that will further attract the individual's attention.

The numbers 36,40, graphical representations 38,42 and/or the words 50,52,54,56 may be used to create a story associated with the arithmetic operation for each individual card. The stories can be used to reinforce the arithmetic operation or provide a mnemonic device for remembering the solution to the problem. The third, answer number may be depicted as part of the story and follows from, and is tied into, the first two numbers. The individual backgrounds/settings specific to each combination of three numbers set the stage for the story and tie it together. In addition to using stories, the cards can also include rhymes. Such devices are powerful memory techniques which have been shown to enhance recall. Furthermore, such devices help provide additional interaction for the individual with the method and system.

Additional devices may be used to help the individual determine the answer to the arithmetic operation and problem. For example, clues or suggestions can be used to lead the user toward the correct answer. One such type of clue would be using word phrases such as “one for the money” where the words “one for” may be indicative of the answer of fourteen. Furthermore, these clues may be set off from the other text and/or graphical representations shown on the faces of the cards. For example, the clues or suggestions may be highlighted in a different color, such as red, than the remaining text which may be black.

The graphical representations, words and clues may all be used as part of a story for each card and each arithmetic operation. For example, all of these devices may be used in the arithmetic operation of two multiplied times seven to give an answer of fourteen. This card could include a front side having the numbers two and seven and a graphical representation of a two-faced character interacting with a graphical representation of the seven dwarfs mining for gold. There may be text such as “one for the money, two for the show, three to get ready, four to . . . gold.” The text “one for” may be displayed in red text whereas all of the remaining text may be black. The back side of the card could include the number fourteen shaped and designed out of bricks of gold with further graphical representations of fourteen-karat gold. The story as well as the associated graphical representations and clues can reinforce this particular arithmetic operation for the individual. Similar stories and cards can be designed for a variety of other numbers and arithmetic operations. In a preferred form, the “answer” number is depicted as part of a story and follows from, and is tied into, the first two numbers. Individual backgrounds/settings specific to each combination of three numbers may set the stage for the story and tie it together. Overall, the method and system can include a variety of devices as outlined above to maintain the interest of the individual as well as increase recall.

Though described above as a method and system including a plurality of cards, the present invention may take a variety of other forms that have also been contemplated. For example, instead of using physical cards or other printed media, the method and system may be embodied on an electronic screen, such as a computer monitor or television. For example, the method and system may be embodied in software that can be used on a computer by an individual. The software may be interactive requiring input from the individual to progress from the problem to the answer as well as to progress to the next problem. Similarly, the method and system may be embodied on an interactive video, such as found on DVDs or video games. The DVD may require interaction from the user to progress from the problem to the answer as well as to progress to the next problem. The software, video games and/or DVD may include additional features such as music, sounds and voices. The voices may be used to read the text that is shown on the screen. The voices may also provide additional information beyond what is found on the screen.

Any other object might be used that is capable of conveying the images/graphical representations. For example, even a three dimensional object, such as a sculpture, might be used for this purpose.

While many, if not all, of the images/graphical representations will be recognized by those practicing the method as relating to a subject matter commonly identified with a number in conjunction with at least one other word (three little pigs, seven dwarfs, etc.), pre-training of individuals to better equip them to use the inventive learning method may be carried out. Pre-training consists of the following two-step process.

For purposes of simplicity, the pre-training is described relative to a visual conveyance of information to an individual. This is representative in nature only, since the conveyance of information to the individual may be made through any of the user's senses (sight, sound, feel, etc.). The pre-training is applicable to the method regardless of how the individual acquires the same.

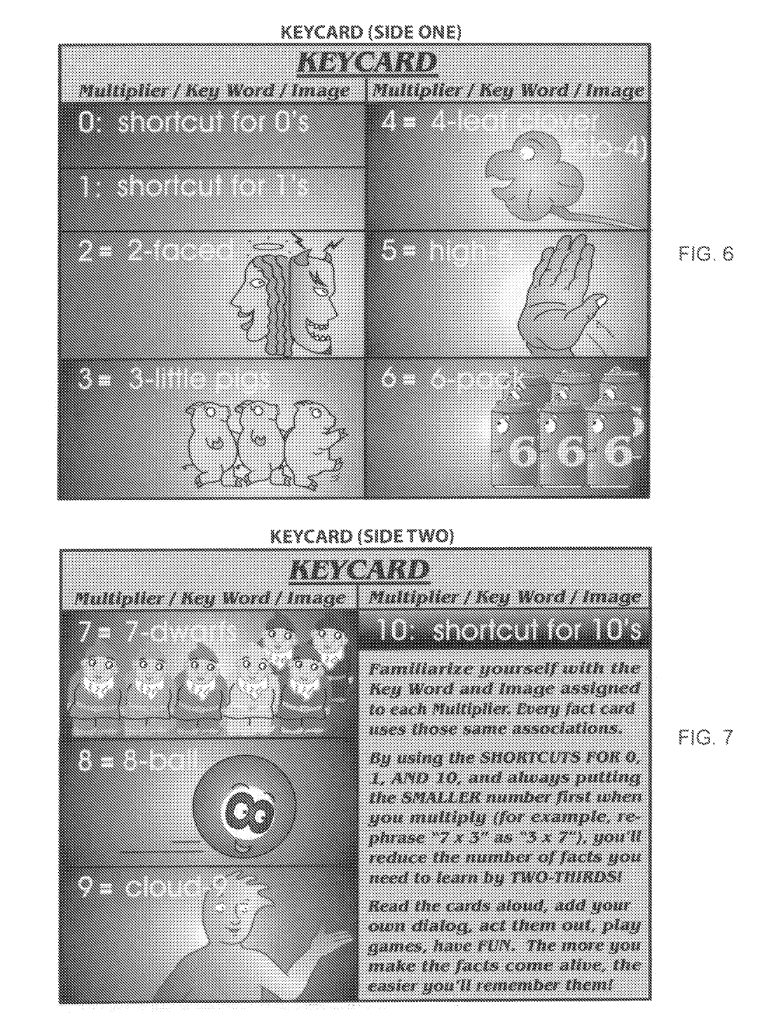

In step one, the individual, who may be a student, is presented with a first viewable object which visually conveys a key image/graphical representation whose understood (commonly or through pre-training) name includes a number and descriptive text, through one or more words (e.g., the image of a “six pack” of soda cans), in conjunction with a number and a name corresponding to that image (e.g., “6=6-pack”). There are several different key images (e.g., a head with two faces, three little pigs, a four-leaf clover, etc.), each of which is paired with its own corresponding number and name (e.g., “2-faced”, “3-little pigs”, “4-leaf clover”, etc.). The student is given information to familiarize himself/herself with the key images/graphical representation, then names (common or taught) and their corresponding numbers as shown in the sample card in FIGS. 6 and 7.

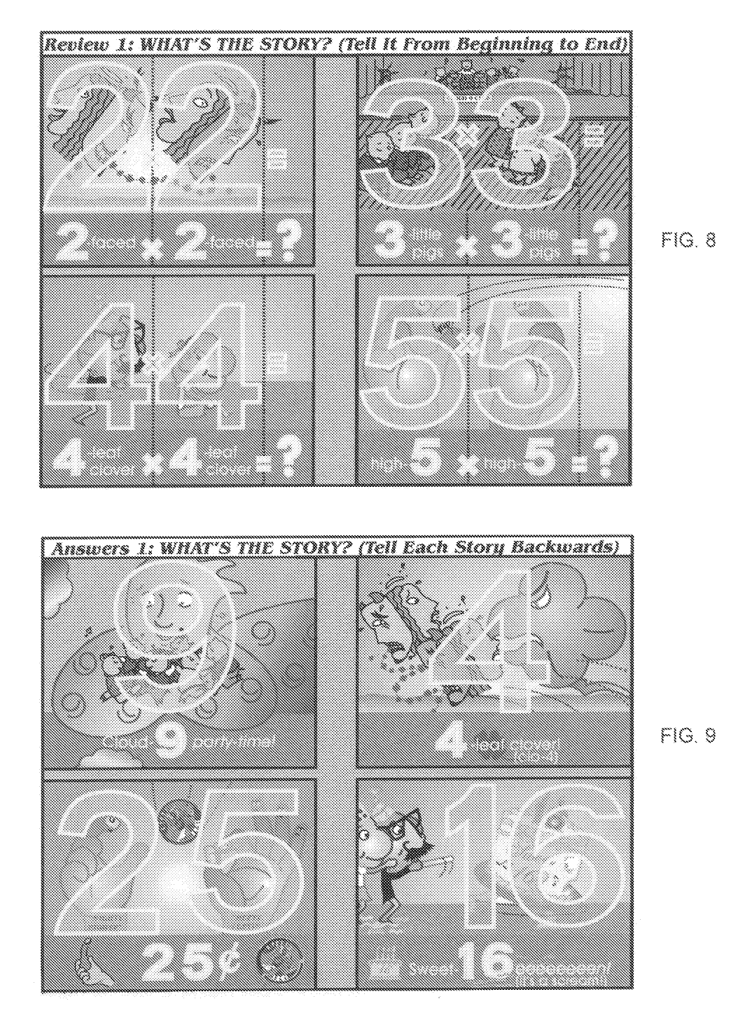

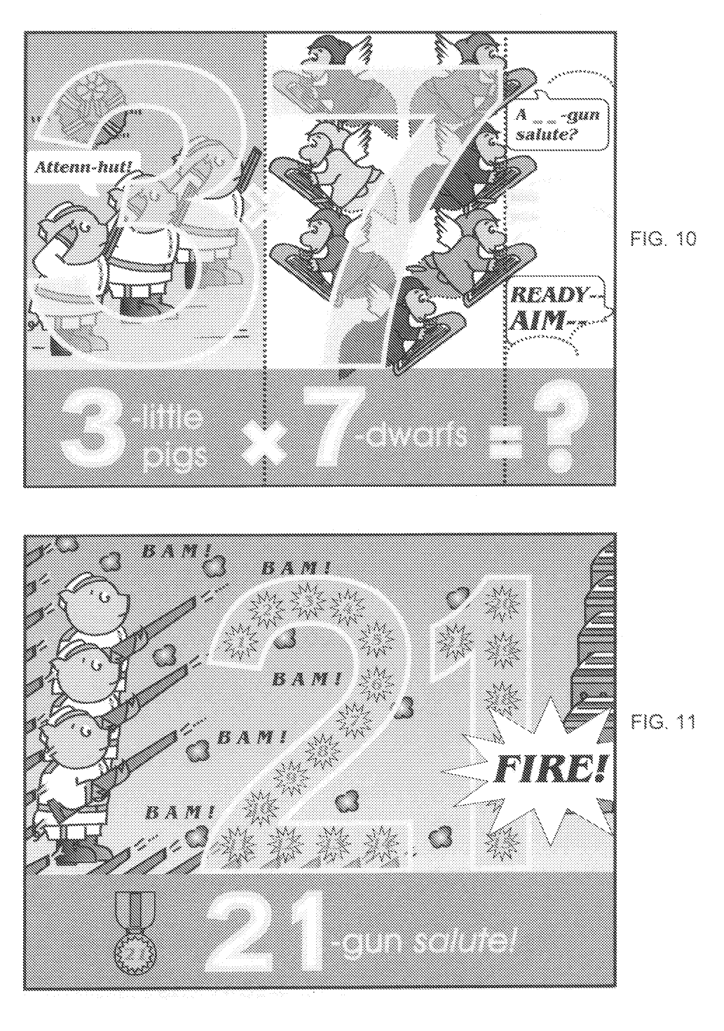

In step two, the student is presented with a second viewable object which visually conveys: (1) a sample arithmetic problem consisting of a key image whose understood (commonly know or pre-trained) name includes a number and descriptive text, followed by a symbol for an arithmetic function (e.g., “×”), followed by a second key image whose understood name includes a number and descriptive text, followed by the mathematical equality sign (“=”), and ending with a question or symbol (e.g., “?”) to indicate a question that prompts the student to solve the math problem and a “hint” in the form of an image and/or text suggesting the answer, directly or indirectly (see sample card in FIGS. 8 and 10) and (2) a final image, containing a number and descriptive text, that is a resultant of the mathematical operation expressed by the preceding two numbers. A sample card is shown in FIGS. 9 and 11.

In one more specific form, using a two-sides card, once the pre-training is completed, the student is presented with the front side of at least one other viewable object which may be a card or other object, which visually conveys an arithmetic problem whose numerals are portrayed by the key images that correspond to those numerals (e.g., “3×7” would be portrayed as “3-little pigs×7-dwarfs”) as shown in FIG. 10. These images are presented in a context (an individualized setting accompanied by images, numbers, text and/or dialog) that forms the beginning of a story or narrative, express or implied. The student should attempt to solve the arithmetic problem by stating the number that follows as a logical outcome of the story or narrative, or helps to conclude the story or narrative, and that is a resultant of the mathematical operation of the preceding two numbers (e.g., “21” (3×7=21)).

In the event that the student is unable to solve the arithmetic problem, the student is presented with the back side of the at least one other viewable object, or a separate object, that is a card or other object, as seen in FIGS. 9 and 11, which visually conveys a final image and descriptive text that follow as a logical outcome of the story or narrative, or helps to finish or conclude the story or narrative, and wherein the final image and descriptive text represent a number that is a resultant of the mathematical operation expressed by the preceding two numbers. For example, if the first and second images contained the numbers “3” and “7” and descriptive text “little pigs” and “dwarfs”, respectively, then the final image would contain the number “21” and descriptive text “gun salute”, so that the final image helps to finish the story or narrative, and in doing so contains the number that is the result of the operation of the first two numbers (e.g., “3-little pigs”×“7-dwarfs”=21-gun salute”).

To summarize, the arithmetic equation “3×7=21” is portrayed as follows: in the event a card is used, on the front side of the card, the two multipliers “3×7” are visually portrayed as 3 little pigs in military uniform accompanied by 7 departed dwarfs whose souls float above their military coffins; and on the back side of the card, the product of the two multipliers (3×7), “21”, is visually portrayed as the 3 little pigs firing a “21-gun salute” in honor of the 7 departed dwarfs.

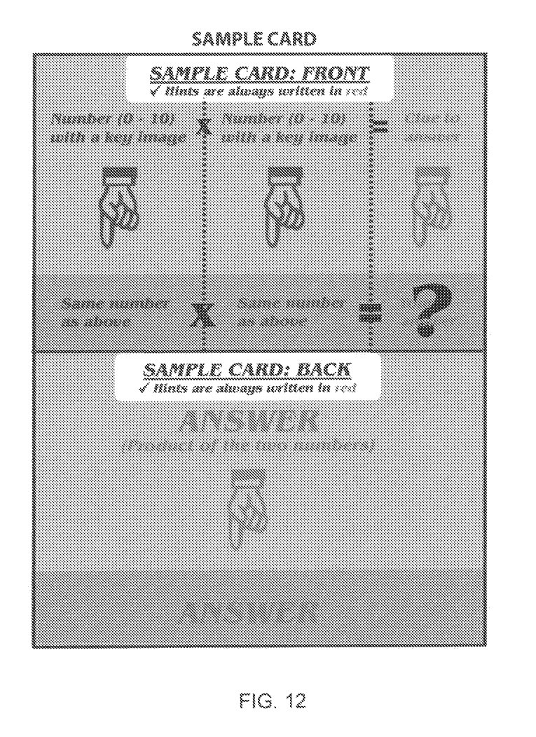

In FIG. 12, a generic format for the method described with respect to FIGS. 8-11 is set forth, again in a card format, which should not be viewed as limiting.

While including a pre-training step may make the learning method usable to a wider base, it is not necessary to make the method functional or usable for a significant percent of the age group at which it is directed. An objective of the invention is to make arithmetic exercises easier and commit certain numerical manipulations to memory without requiring excessive repetition and rote memorization. To do so, images/representations are used that are commonly identifiable by even a young audience with the pertinent numbers in conjunction with at least one other word—such as an “8 ball”, “7 dwarfs”, etc.

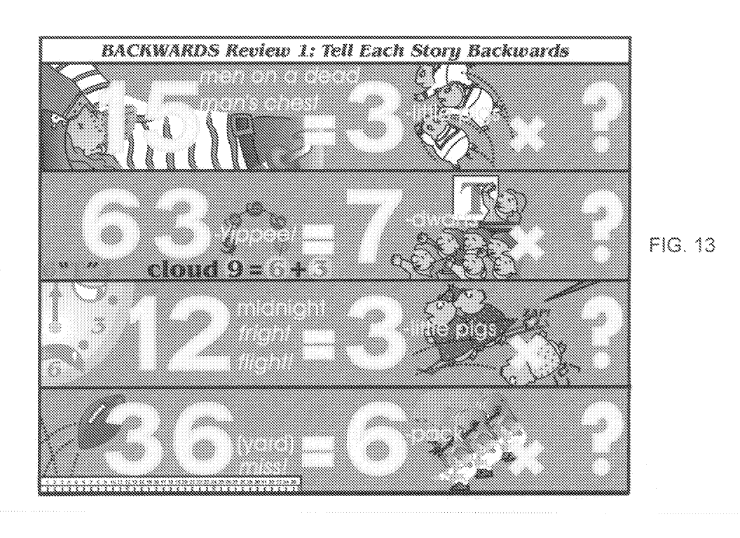

FIG. 13 shows a variation wherein the inventive method is practiced backwards using the same concept and requiring the individual to identify one of two members on which an operation is performed with only the other of the two numbers and the resultant/answer number identified. More specifically, the front side of another set of review cards is the answer (with its corresponding key image with descriptive text, number and name), followed by an equal sign, followed by the sign for an arithmetic function (e.g., “×”), and followed by a question mark (e.g., “?”). In the embodiment shown, these are arranged four to a page (out of order) and prompt the individual to “tell each story backwards”. On the back side of each there is the corresponding second number (with its corresponding key image with descriptive text, number and name) and another prompt that the individual “tell each story backwards”.

Various games may be played using the above basic concepts to further stimulate user interest.

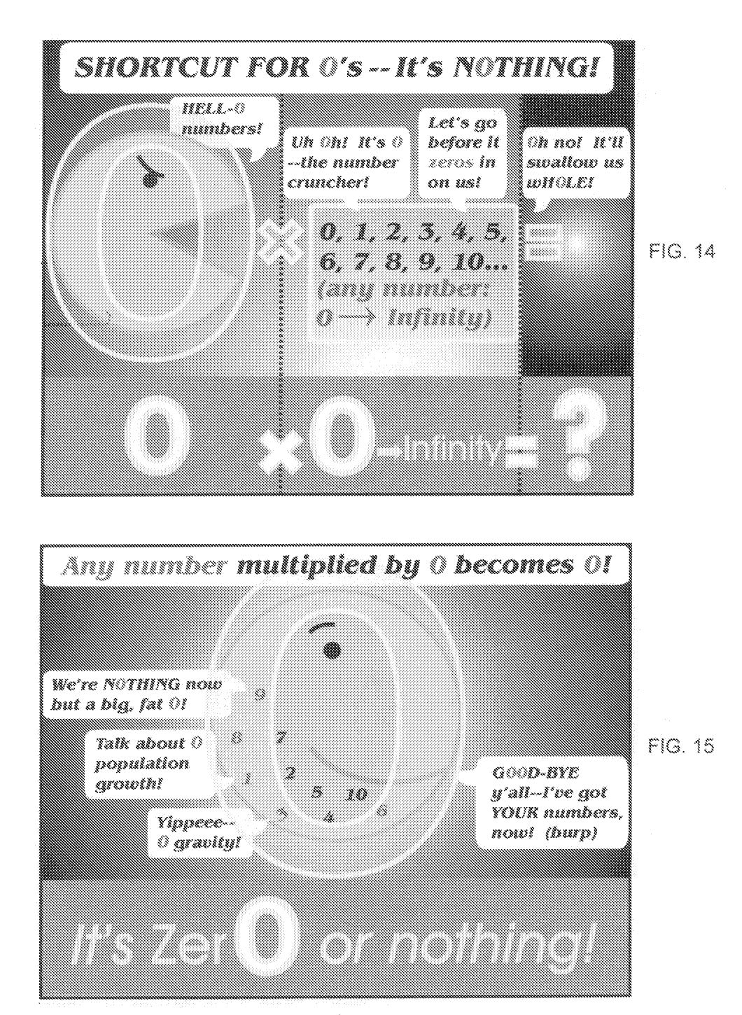

“Shortcut Cards” for the numbers 0, 1 and 10 are shown in FIGS. 14 and 15. The front of each card (not shown) may show the number with a corresponding image (10 may be portrayed as a cowboy with a ten-gallon heat) and accompanying text, followed by the sign for an arithmetic function (e.g., “×”), followed by numbers 0 through infinity as seen in FIG. 14, followed by an equal sign, and followed by a question mark. The back of each card, as seen in FIG. 15, shows the answer (e.g., any number multiplied by “0” becomes “0”).

The foregoing disclosure of specific embodiments is intended to be illustrative of the broad concepts comprehended by the invention.

1. A learning method comprising the steps of:
providing at least one viewable object;
through the at least one viewable object visually conveying to an individual a first number or a suggestion of a first number through a first image on the at least one viewable object comprising at least one of (a) at least one of a person, place or thing understood to be identified with the first number in conjunction with at least one word and (b) a characteristic of at least one of a person, place or thing commonly identified with the first number in conjunction with the at least one word,
the first image relating to a first part of a story;
through the at least one viewable object, visually conveying to the individual a second number or a suggestion of a second number through a second image on the at least one viewable object comprising at least one of (a) at least one of a person, place or thing understood to be identified with the second number in conjunction with at least one other word and (b) a characteristic of at least one of a person, place or thing understood to be identified with the second number in conjunction with the at least one other word,
the second image relating to a part of the story; and
through the at least one viewable object, visually conveying to the individual one of a) a suggestion of a third number and b) the third number that is the result of a first arithmetic operation using the first and second numbers through a third image on the at least one viewable object comprising at least one of (a) at least one of a person, place or thing understood to be identified with the third number in conjunction with at least another word and (b) a characteristic of at least one of a person, place or thing understood to be identified with the third number in conjunction with the at least another word,
the third image relating to an outcome of the story and related to the first and second images so that an individual is led through the first and second images to conclude the story with the outcome to which the third image relates.

2. The learning method according to claim 1 wherein the first and second numbers are the same.

3. The learning method according to claim 1 wherein the first and second numbers are different.

4. The learning method according to claim 1 further comprising the step of conveying to the individual one or more words suggesting the third number.

5. The learning method according to claim 1 wherein the steps of conveying are performed through visual communication.

6. The learning method according to claim 1 wherein at least one of the conveying steps comprises conveying to the individual through printed media.

7. The learning method according to claim 1 further comprising the step of pre-training the individual so that the individual understands an intended relationship between at least one of the images and a number associated with the at least one of the images and identified with a number in conjunction with at least one word.

8. A learning method comprising the steps of:
conveying to an individual a first number through a first graphical representation that relates to subject matter understood to be identified with the first number in conjunction with at least one other word;
conveying to the individual a symbol for a first arithmetic operation;
conveying to the individual a second number through a second graphical representation that relates to subject matter understood to be identified with the second number in conjunction with at least one other word; and
conveying to the individual at least one word associated with at least one of the first and second graphical representations, the at least one word containing information suggesting a third number that is a result of performing the first arithmetic operation using the first and second numbers without identifying the third number by itself,
wherein at least one of the conveying steps comprises conveying through printed media what is observed by the individual.

9. The learning method of claim 8 wherein the first graphical representation includes at least one of (a) at least one of a person, place or thing and (b) a characteristic of at least one of a person, place or thing understood to be identified with the first number in conjunction with at least one other word.

10. The learning method of claim 9 wherein the second graphical representation includes at least one of (a) at least one of a person, place or thing and (b) a characteristic of at least one of a person, place or thing commonly identified with the second number in conjunction with at least one other word.

11. The learning method of claim 8 wherein the first and second numbers are the same.

12. The learning method of claim 8 wherein the first and second numbers are the different.

13. The learning method of claim 8 wherein the first and second graphical representations are the same.

14. The learning method of claim 8 wherein the first and second graphical representations are different.

15. The learning method according to claim 8 further comprising the step of pre-training the individual so that the individual understands an intended relationship between at least one of the images and a number associated with the at least one of the images and identified with a number in conjunction with at least one word.

16. A system for learning arithmetic operations, the system comprising:
a plurality of cards,
the cards each having a front side and a back side,
the front side of a first card including a first number together with a first graphical representation that is understood to be identified with the first graphical representation in conjunction with at least one other word, a second number together with a second graphical representation understood to be identified with the second number in conjunction with at least one other word, a symbol for a first arithmetic operation and a word associated with at least one of the first and second graphical representations, the word containing a clue suggesting a third number that is a result of the first arithmetic operation without identifying the third number by itself,
the back side of the first card including the third number or a graphical representation that is understood to be identified with the third number in conjunction with at least one other word.

17. The system of claim 16 wherein the first and second numbers are the same.

18. The system of claim 16 wherein the first and second numbers are the different.

19. The system of claim 16 wherein the first and second graphical representations are the same.

20. The system of claim 16 wherein the first and second graphical representations are different.
